(19) United States
(12) Patent Application Publication
(10) Pub. No.: US 2015/0165968 A1
(43) Pub. Date: Jun. 18, 2015

(54) WARNING SOUND SYSTEM FOR VEHICLE AND METHOD FOR CONTROLLING THE SYSTEM

(71) Applicant: HYUNDAI MOTOR COMPANY, Seoul (KR)

(72) Inventor: Seong Un KIM, Anyang-si (KR)

(21) Appl. No.: 14/516,406

(22) Filed: Oct. 16, 2014

(30) Foreign Application Priority Data
Dec. 18, 2013 (KR) 10-2013-0157981

(51) Int. Cl. B60Q 5/00; G08G 1/123

(52) U.S. Cl. CPC B60Q 5/008; G08G 1/123

(57) ABSTRACT

A warning sound system for a vehicle and a method for controlling the system are disclosed. The method for controlling the warning sound system for the vehicle according to an exemplary embodiment of the present invention may include determining whether the vehicle enters a specific area based on a current position of the vehicle, determining an audio frequency that corresponds to the specific area when the vehicle enters the specific area, amplifying a warning sound having the audio frequency that corresponds to the specific area to a basic sound pressure via an amplifier, and outputting the warning sound via a speaker.

### CROSS-REFERENCE TO RELATED APPLICATION

This application claims the benefit of priority to Korean Patent Application No. 10-2013-0157981 filed in the Korean Intellectual Property Office on Dec. 18, 2013, the entire contents of which are incorporated herein by reference.

### TECHNICAL FIELD

The present disclosure relates to a warning sound system for a vehicle and a method for controlling the system. More particularly, the present disclosure relates to a warning sound system for outputting a warning sound having an audio frequency appropriate for a pedestrian who has insufficient ability to judge a situation, and a method for controlling the system.

### BACKGROUND

In general, hybrid electric vehicles, electric vehicles, and fuel cell vehicles, which are usually called environmentally-friendly vehicles, are driven by a drive motor that generates a torque from electrical energy.

An environmentally-friendly vehicle driven only by the drive motor hardly generates a noise, and thus, it may be difficult for pedestrians to recognize approach of the vehicle. As a countermeasure, a virtual engine sound system (VESS) that outputs a virtual engine sound via a speaker to allow the pedestrians to recognize the approach of the vehicle has been developed.

Particularly, children may be easily in a dangerous situation because it is difficult for children to recognize approach of the vehicle. Further, since a frequency of the virtual engine sound output from the conventional virtual engine sound system is fixed, it is difficult to selectively provide the virtual engine sound to children who have insufficient ability to judge a situation.

Technologies related to a gasoline vehicle, a diesel vehicle, or an LPG vehicle have been developed to reduce a noise generated from the vehicle, however, the above-mentioned problem is remained.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a warning sound system for a vehicle and a method for controlling the system having advantages of outputting an appropriate warning sound to children and adolescents who have insufficient ability to recognize a situation by using an audio frequency characteristic of each age.

A warning sound system for a vehicle according to an exemplary embodiment of the present invention may include a navigation device configured to detect a current position of the vehicle. A controller is configured to determine an audio frequency that corresponds to a specific area when the vehicle enters the specific area. An amplifier is configured to amplify a warning sound having the audio frequency that corresponds to the specific area. A speaker is configured to output the amplified warning sound. The audio frequency varies according to an age group that corresponds to the specific area.

The specific area may include a children protection zone and a road in the vicinity of a school.

The audio frequency may be preset to correspond to a type of a school located within the specific area.

The controller may amplify the warning sound to a basic sound pressure, which is preset in a memory, via the amplifier.

The warning sound system may further include an imaging device configured to photograph the outside of the vehicle and to generate image information. The controller determines whether a pedestrian exists within a danger radius using the image information, and corrects the basic sound pressure when the pedestrian exists within the danger radius.

The warning sound system may further include a display device configured to display information regarding operations of the warning sound system. The controller displays information indicating that the warning sound is being output via the display device.

The controller may display a message indicating detections of the pedestrian via the display device when the pedestrian exists within the danger radius.

A method for controlling a warning sound system for a vehicle may include determining whether the vehicle enters a specific area based on a current position of the vehicle. An audio frequency that corresponds to the specific area is determined when the vehicle enters the specific area. A warning sound having the audio frequency that corresponds to the specific area is amplified to a basic sound pressure via an amplifier. The warning sound is output via a speaker. The audio frequency varies according to an age group that corresponds to the specific area.

The specific area may include a children protection zone and a road in the vicinity of a school.

The audio frequency may be preset to correspond to a type of a school located within the specific area.

The method may further include displaying information indicating that the warning sound is being output via a display device.

The method may further include determining whether a pedestrian exists within a danger radius using image information and correcting the basic sound pressure when the pedestrian exists within the danger radius.

The method may further include displaying a message indicating detection of the pedestrian via the display device when the pedestrian exists within the danger radius.

According to an exemplary embodiment of the present invention, the warning sound that corresponds to the audio frequency appropriate for an age group may be output when the vehicle enters the specific area. Pedestrians such as children and adolescents may recognize approach of the vehicle through the warning sound.

Further, the appropriate warning sound may be accurately provided to the children and adolescents who have insufficient ability to judge and to recognize a dangerous situation in comparison with adults. In other words, the appropriate warning sound may arouse attention of the pedestrians such as the children and adolescents, thereby making it possible to ensure safe walking of the pedestrians.

Because the warning sound may have an audio frequency that is set as a frequency capable of being recognized by only children and adolescents, drivers and pedestrians, other than children and adolescents, may not recognize the warning sound, and therefore, will not be stressed by the sound.

### BRIEF DESCRIPTION OF THE DRAWINGS

FIG. 1 is a block diagram of a warning sound system for a vehicle according to an exemplary embodiment of the present invention.

FIG. 2 is a flowchart of a method for controlling a warning sound system according to an exemplary embodiment of the present invention.

### DETAILED DESCRIPTION

Hereinafter, the present invention will be described more fully with reference to the accompanying drawings, in which exemplary embodiments of the invention are shown.

As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

Further, since each component shown in the drawings is arbitrarily illustrated for easy description, the present disclosure is not particularly limited to the components illustrated in the drawings.

A vehicle in which a warning sound system according to an exemplary embodiment of the present invention is mounted may be a hybrid electric vehicle, an electric vehicle, a fuel cell vehicle, a gasoline vehicle, a diesel vehicle, or an LPG vehicle.

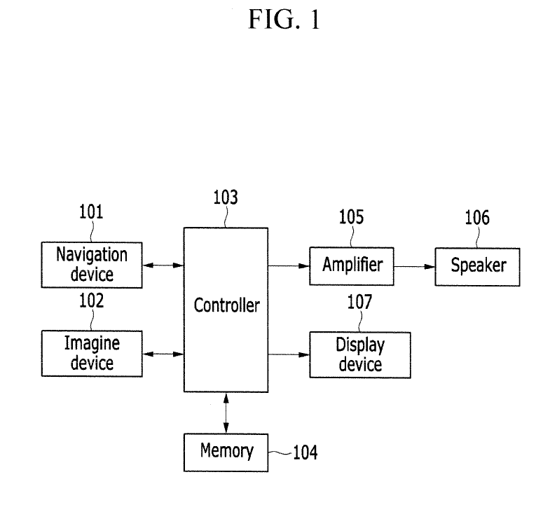

FIG. 1 is a block diagram of a warning sound system for a vehicle according to an exemplary embodiment of the present invention.

As shown in FIG. 1, a warning sound system for a vehicle according to an exemplary embodiment of the present invention may include a navigation device 101, an imaging device 102, a controller 103, a memory 104, an amplifier 105, a speaker 106, and a display device 107.

The navigation device 101 may be configured to guide a driver of a route to a destination. The navigation device 101 may include input and output portions to input and output, respectively, information for guidance of the route. A current position detecting portion detects information regarding a current position of the vehicle. A memory stores map data for calculating the route and guide data for guiding the route. A control portion searches the route and performs the guidance of the route. The navigation device 101 may be configured to calculate the current position of the vehicle based on a signal transmitted from a global positioning system (GPS) satellite, and transmit information regarding the current position to the controller 103.

The imaging device 102 (e.g., a camera, a video camera, or the like) may be mounted at a front side, a rear side, a left side, or a right side of the vehicle, and configured to photograph the outside of the vehicle. The imaging device 102 may be configured to process an image frame such as a still image or a motion picture obtained by an image sensor in a photograph mode. Image information generated by the imaging device 102 may be transmitted to the controller 103.

The controller 103 controls the warning sound system. The controller 103 may be implemented with one or more microprocessors executed by a predetermined program. The predetermined program may include a series of commands for performing each step included in a method for controlling the warning sound system according to an exemplary embodiment of the present invention.

The controller 103 determines whether the vehicle enters a specific area based on the current position of the vehicle. The specific area may be set to an area which is determined by those skilled in the art. For example, the specific area may include a children protection zone and a road in the vicinity of a school.

When the vehicle enters the specific area, the controller 103 determines an audio frequency that corresponds to the specific area. The audio frequency may be preset to correspond to a type of a school (e.g., a kindergarten, an elementary school, a middle school, or a high school) located within the specific area, and may be stored in the memory 104. For example, the audio frequency may be set as a frequency (e.g., 16 kHz) capable of being recognized by only children and adolescents, and may vary according to an age group that corresponds to the specific area.

The amplifier 105 may be configured to amplify a warning sound having the determined audio frequency. The controller 103 may amplify the warning sound to a basic sound pressure, which is preset in the memory 104, via the amplifier 105. The amplified warning sound is output via the speaker 106.

The display device 107 may be configured to display information regarding operations of the warning sound system. The display device 107 may be mounted in a cluster in a predetermined form. The controller 103 may display information indicating that the warning sound is being output via the display device 107. Accordingly, the driver may safely drive the vehicle by being informed of pedestrians such as children and adolescents.

The controller 103 may determine whether a pedestrian exists within a danger radius using image information input from the imaging device 102. The danger radius may be preset with reference to the vehicle.

The controller 103 may correct the basic sound pressure when the pedestrian exists within the danger radius. In other words, the controller 103 may amplify the warning sound to a correction sound pressure, which is greater than the basic sound pressure, via the amplifier 105 by applying setting values of a volume table stored in the memory 104. When determining the correction sound pressure, a harmonic component generated by using the amplifier 105 may be considered.

Accordingly, an appropriate warning sound may be accurately transmitted to children and adolescents who have insufficient ability to judge and to recognize a dangerous situation. The appropriate warning sound may arouse attention of pedestrians such as children and adolescents, thereby making it possible to ensure safe walking of the pedestrians.

When the pedestrian exists within the danger radius after the vehicle enters the specific area, the controller 103 displays a message indicating detection of the pedestrians via the display device 107 to induce safe driving of the driver.

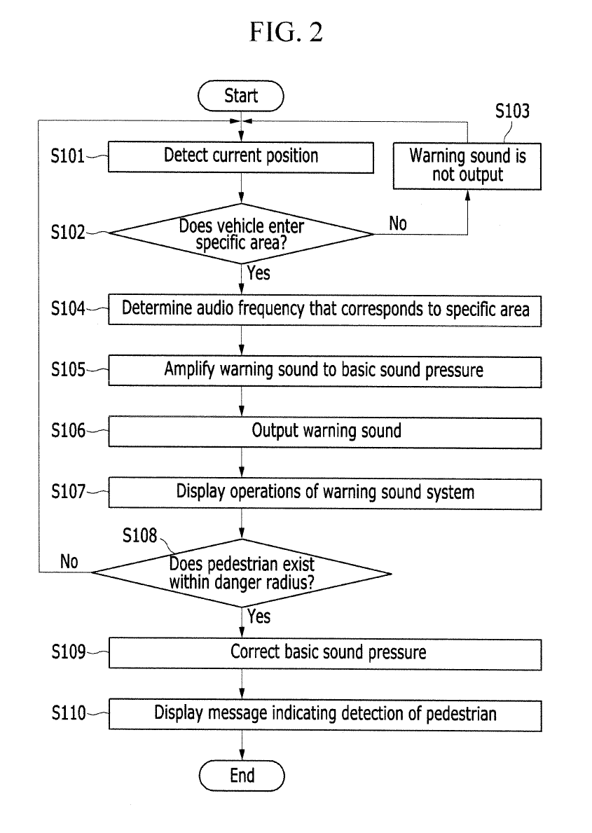

Hereinafter, referring to FIG. 2, a method for controlling the warning sound system according to an exemplary embodiment of the present invention will be described in detail.

FIG. 2 is a flowchart of a method for controlling a warning sound system according to an exemplary embodiment of the present invention.

As shown in FIG. 2, the method for controlling the warning sound system according to an exemplary embodiment of the present invention begins with detecting a current position of a vehicle at step S101. The navigation device 101 detects the current position of the vehicle and transmits a signal corresponding thereto to the controller 103.

The controller 103 determines whether the vehicle enters the specific area based on the current position of the vehicle at step S102. The specific area may be set to an area which is determined by those skilled in the art. For example, the specific area may include a children protection zone and a road in the vicinity of a school.

When the vehicle does not enter the specific area at step S102, a warning sound according to an exemplary embodiment of the present invention is not output at step S103.

When the vehicle enters the specific area at step S102, the controller 103 determines an audio frequency that corresponds to the specific area at step S104. The audio frequency may be preset to correspond to a type of a school (e.g., a kindergarten, an elementary school, a middle school, or a high school) located within the specific area. For example, the audio frequency may be set as a frequency (e.g., 16 kHz) capable of being recognized by only children and adolescents, and may vary according to an age group that corresponds to the specific area.

The controller 103 amplifies a warning sound having the determined audio frequency to a basic sound pressure via the amplifier 105 at step S105. The basic sound pressure may be preset in the memory 104.

The controller 103 outputs the amplified warning sound via the speaker 106 at step S106. Pedestrians such as children and adolescents may recognize approach of the vehicle through the warning sound.

The controller 103 may display information indicating that the warning sound is being output via the display device 107 at step S107. Accordingly, the driver may safely drive the vehicle by being notified of the pedestrians.

The controller 103 determines whether a pedestrian exists within a danger radius using image information input from the imaging device 102 at step S108. The danger radius may be preset with reference to the vehicle.

When the pedestrian does not exist within the danger radius at step S108, the controller 103 may proceed to step S101.

When the pedestrian exists within the danger radius at step S108, the controller 103 may correct the basic sound pressure at step S109. In other words, the controller 103 may amplify the warning sound to a correction sound pressure, which is greater than the basic sound pressure, via the amplifier 105 by applying setting values of a volume table stored in the memory 104. When determining the correction sound pressure, a harmonic component generated by using the amplifier 105 may be considered.

Accordingly, an appropriate warning sound may be accurately provided to the children and adolescents who have insufficient ability to judge and to recognize a dangerous situation in comparison with adults. The appropriate warning sound may arouse attention of the pedestrians such as the children and adolescents, thereby making it possible to ensure safe walking of the pedestrians.

When the pedestrian exists within the danger radius after the vehicle enters the specific area, the controller 103 displays a message indicating detection of the pedestrian via the display device 107 to induce safe driving of the driver at step S110.

The controller 103 may warn a danger of a collision to the driver via the display device 107 or an interior speaker when there is a possibility of colliding with a pedestrian, another vehicle, or an obstacle.

As described above, according to an exemplary embodiment of the present invention, the warning sound that corresponds to the audio frequency appropriate for an age group may be output when the vehicle enters the specific area. Pedestrians such as children and adolescents may recognize approach of the vehicle through the warning sound.

Further, the appropriate warning sound may be accurately provided to children and adolescents who have insufficient ability to judge and to recognize a dangerous situation in comparison with adults. In other words, the appropriate warning sound may arouse attention of pedestrians such as children and adolescents, thereby making it possible to ensure safe walking of the pedestrians.

While this invention has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

What is claimed is:

1. A warning sound system for a vehicle, comprising:
a navigation device configured to detect a current position of the vehicle;
a controller configured to determine an audio frequency that corresponds to a specific area when the vehicle enters the specific area;
an amplifier configured to amplify a warning sound having the audio frequency that corresponds to the specific area; and
a speaker configured to output the amplified warning sound,
wherein the audio frequency varies according to an age group that corresponds to the specific area.

2. The warning sound system of claim 1, wherein the specific area includes a children protection zone and a road in the vicinity of a school.

3. The warning sound system of claim 1, wherein the audio frequency is preset to correspond to a type of a school located within the specific area.

4. The warning sound system of claim 1, wherein the controller amplifies the warning sound to a basic sound pressure, which is preset in a memory, via the amplifier.

5. The warning sound system of claim 4, further comprising an imaging device configured to photograph the outside of the vehicle and generate image information,
wherein the controller is configured to determine whether a pedestrian exists within a danger radius using the image information and to correct the basic sound pressure when the pedestrian exists within the danger radius.

6. The warning sound system of claim 5, further comprising a display device configured to display information regarding operations of the warning sound system,
wherein the controller displays information indicating that the warning sound is being output via the display device.

7. The warning sound system of claim 6, wherein the controller displays a message indicating detection of the pedestrian via the display device when the pedestrian exists within the danger radius.

8. A method for controlling a warning sound system for a vehicle, comprising steps of:
determining whether the vehicle enters a specific area based on a current position of the vehicle;
determining an audio frequency that corresponds to the specific area when the vehicle enters the specific area;
amplifying a warning sound having the audio frequency that corresponds to the specific area to a basic sound pressure via an amplifier; and
outputting the warning sound via a speaker,
wherein the audio frequency varies according to an age group that corresponds to the specific area.

9. The method of claim 8, wherein the specific area includes a children protection zone and a road in the vicinity of a school.

10. The method of claim 8, wherein the audio frequency is preset to correspond to a type of a school located within the specific area.

11. The method of claim 8, further comprising a step of displaying information indicating that the warning sound is being output via a display device.

12. The method of claim 11, further comprising steps of:
determining whether a pedestrian exists within a danger radius using image information; and
correcting the basic sound pressure when the pedestrian exists within the danger radius.

13. The method of claim 12, further comprising displaying a message indicating detection of the pedestrian via the display device when the pedestrian exists within the danger radius.

14. A non-transitory computer-readable recording medium comprising computer executable instructions of which cause a controller to perform the method according to claim 8.
